(19) United States
(12) Patent Application Publication
(10) Pub. No.: US 2008/0019256 A1
(43) Pub. Date: Jan. 24, 2008

(54) Objective lens and optical pickup system

(75) Inventors: Mitsuhiro Miyauchi, Ibaraki-shi (JP); Koichiro Wakabayashi, Ibaraki-shi (JP); Yoshikazu Mitsui, Ibaraki-shi (JP); Yasuyuki Sugi, Ibaraki-shi (JP); Yutaka Makino, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-shi (JP)

(21) Appl. No.: 11/826,623

(22) Filed: Jul. 17, 2007

(30) Foreign Application Priority Data
Jul. 18, 2006 (JP) 2006-195453

(51) Int. Cl. G02B 3/02; G11B 7/00; G11B 7/135

(52) U.S. Cl. 369/112.23; 359/719

(57) ABSTRACT

There is provided an optical pickup system which includes a first light source emitting first light having a wavelength λ1, a second light source emitting second light having a wavelength λ2 longer than the wavelength λ1, a third light source emitting third light having a wavelength λ3 longer than the wavelength λ2, and an objective lens focusing the first light on an information recording surface of a first optical recording medium, focusing the second light on an information recording surface of a second optical recording medium, and focusing the third light on an information recording surface of a third optical recording medium. In the optical pickup system, at least one lens surface of the objective lens is divided into a plurality of concentric sections with an optical axis, having a step at each boundary between the sections, each of the sections has a different aspherical shape and m1>m2>0 and −0.060≦m3≦−0.020 are satisfied where an imaging magnification at the first light is m1, an imaging magnification at the second light is m2, and an imaging magnification at the third light is m3 in the objective lens. This enables a decrease in aberration at the first light and the second light and an increase in object distance at the third light. Further, this step enables the shared use of a photodetector for detecting the first light and a photodetector for detecting the second light.

### BACKGROUND OF THE INVENTION

1. Field of the Invention

The present invention relates to an objective lens and an optical pickup system. Particularly, the present invention relates to an objective lens and an optical pickup system used in a recording and playback apparatus which is compatible with various optical recording media, that is a multi-wavelength optical system using a plurality of kinds of monochromatic light.

2. Description of Related Art

High density optical discs with the use of blue lasers, such as Blu-ray disc and HD DVD, come into practical use. The recording density of optical discs depends on the diameter of the optical spot focused on an information recording surface. The optical spot diameter is in proportion to λ/NA where λ is the wavelength of light emitted from a light source and NA is an image-side numerical aperture of an objective lens. Accordingly, higher density optical discs can be achieved by shortening the wavelength of laser light for optical pickup and increasing NA of an objective lens.

In a high density optical disc apparatus using blue lasers preferably have compatibility so as to record and playback the existing optical discs such as CD and DVD as well. Such a compatible optical disc apparatus needs to use light sources respectively corresponding to several kinds of optical discs. Further, such a compatible optical disc apparatus may have a plurality of objective lenses corresponding to the kinds of optical discs in an optical pickup and change the objective lenses according to the kind of an optical disc in use, or have a plurality of optical pickups corresponding to the kinds of optical discs and change the optical pickups according to the kind of an optical disc in use.

However, for the cost and device size reduction, it is preferred to use the same optical pickup lens for any kinds of optical discs. An example of such a compatible optical disc apparatus is disclosed in Japanese Unexamined Patent Application Publication No. 2000-348376 (Matsuzaki et al.).

According to Matsuzaki et al., an objective lens which is designed to reduce the aberration for a first disc is placed, and the aberration for second and third discs is reduced by differentiating the optical path length from each light source to the objective lens or by using the diffraction effect with a hologram, thereby enabling recording and playback of all kinds of discs with the use of the same objective lens.

However, the technique taught by Matsuzaki et al. has the following drawbacks. If a different optical path length from each light source to the objective lens is set for each kind of optical disc, it is necessary to use a photodetector corresponding to each kind of optical disc, thus requiring a plurality of photodetectors. If an optical pickup apparatus is composed of a light source, a collimator lens and an objective lens as described in Matsuzaki et al., it is necessary to prepare separate photodetectors for setting a different optical path length corresponding to a distance from a light source to a collimator lens incident surface for each of a first disc and a second disc. For example, three photodetectors are required to establish compatibility among three kinds of optical discs. However, the number of photodetectors is preferably small in terms of cost and size reduction. It is thus preferred to use a common photodetector.

Further, there is a drawback of objective lens shift during tracking. Generally, when parallel light is incident on an objective lens, aberration does not substantially occur even if the objective lens is shifted vertically with respect to the parallel light by tracking. However, the incident light on the objective lens becomes divergent light or convergent light depending on a difference in optical path length from each light source to a collimator lens. As a result, aberration occurs if the objective lens is shifted vertically with respect to an optical axis by tracking. Because Matsuzaki et al. assumes divergent light as the incident light on a collimator lens from a light source corresponding to CD, aberration occurs due to a shift of the objective lens with respect to the optical axis during tracking.

Further, the technique of generating the diffraction effect with the use of a hologram has a drawback of a decrease in diffraction efficiency. Particularly, to establish compatibility among HD DVD, DVD and CD, the use wavelength range is wide (about 400 nm to 800 nm), and it is difficult to assure the diffraction efficiency for each of HD DVD, DVD and CD. Consequently, it fails to obtain high light use efficiency for any of HD DVD, DVD and CD.

The present invention has been accomplished to solve the above problems and an object of the present invention is thus to provide an objective lens capable of achieving suitable recording and playback for a plurality of kinds of optical recording media with the high light use efficiency and the minimized deterioration of wavefront aberration during tracking, and a small-size and low-cost optical pickup system.

### SUMMARY OF THE INVENTION

According to a first aspect of the present invention, there is provided an optical pickup system which includes a first light source emitting first light having a wavelength λ1, a second light source emitting second light having a wavelength λ2 longer than the wavelength λ1, a third light source emitting third light having a wavelength λ3 longer than the wavelength λ2, and an objective lens focusing the first light on an information recording surface of a first optical recording medium, focusing the second light on an information recording surface of a second optical recording medium, and focusing the third light on an information recording surface of a third optical recording medium. In the optical pickup system, at least one lens surface of the objective lens is divided into a plurality of concentric sections with an optical axis, having a step at each boundary between the sections, each of the sections has a different aspherical shape and m1>m2>0 and −0.060≦m3≦−0.020 are satisfied where an imaging magnification at the first light is m1, an imaging magnification at the second light is m2, and an imaging magnification at the third light is m3 in the objective lens. This enables a decrease in aberration at the first light and the second light and an increase in object distance at the third light. Further, this step enables the shared use of a photodetector for detecting the first light and a photodetector for detecting the second light.

According to a second aspect of the present invention, the step and the aspherical shape on at least one lens surface of the objective lens are designed to reduce the spherical aberration for both a first optical recording medium an a second recording medium in the above optical pickup system. According to a third aspect of the present invention, further comprising a divergence angle conversion lens converting the first light and the second light into convergent light, a distance from the first light source to the divergence angle conversion lens and a distance from the second light source to a divergence angle conversion lens are substantially equal in the above optical pickup system of the second aspect. This enables easy reduction of aberration at the first light from the first light source and the second light from the second light source.

According to a fourth aspect of the present invention, the first light source and the second light source are prepared in common package in the above optical pickup system of the third aspect. According to a fifth aspect of the present invention, the above objective lens is made of a material with an Abbe number vd of 50 or higher in the above optical pickup system. Setting the Abbe number of the objective lens to 50 or higher enables reduction of chromatic dispersion, thereby allowing reduction of the number of steps for decreasing aberration at the first light and the second light. According to a sixth aspect of the present invention, the material of the objective lens is plastic in the optical pickup system of the fifth aspect. This enables easy manufacture of the objective lens.

According to a seventh aspect of the present invention, the number of the sections of the above objective lens is 2 to 10 in the above optical pickup system. According to an eighth aspect of the present invention, the above optical pickup system satisfies t1=t2<t3 where a thickness of a transparent substrate of the first optical recording medium is t1, a thickness of a transparent substrate of the second optical recording medium is t2, and a thickness of a transparent substrate of the third optical recording medium is t3. According to a ninth aspect of the present invention, the wavelength λ1 is 380 nm to 430 nm, the wavelength λ2 is 630 nm to 690 nm, and the wavelength λ3 is 760 nm to 810 nm in the above optical pickup system.

According to a tenth aspect of the present invention, there is provided an objective lens for an optical pickup system focusing a light emitted from a first light source having a wavelength λ1 on an information recording surface of a first optical recording medium, focusing a light emitted from a second light source having a wavelength λ2 longer than the wavelength λ1 on an information recording surface of a second optical recording medium, and focusing a light emitted from a third light source having a wavelength λ3 longer than the wavelength λ2 on an information recording surface of a third optical recording medium, recording and/or playback information, and wherein at least one lens surface of the objective lens is divided into a plurality of concentric sections through a certain step with an optical axis, having a step at each boundary between the sections, each of the sections has a different aspherical shape, and m1>m2>0 and −0.060≦m3≦−0.020 are satisfied where an imaging magnification at the light having the wavelength λ1 is m1, an imaging magnification at the light having the wavelength λ2 is m2, and an imaging magnification at the light having the wavelength λ3 is m3 in the objective lens.

According to an eleventh aspect of the present invention, the step and the aspherical shape on at least one lens surface of the objective lens are designed to reduce the spherical aberration for both a first optical recording medium an a second recording medium in the above objective lens. According to a twelfth aspect of the present invention, the objective lens is made of a material with an Abbe number vd of 50 or higher.

According to a thirteenth aspect of the present invention, the material of the objective lens according to the twelfth aspect is plastic. According to a fourteenth aspect of the present invention, the number of the sections of the above objective lens is 2 to 10.

According to a fifteenth aspect of the present invention, the above objective lens satisfies t1=t2<t3 where a thickness of a transparent substrate of the first optical recording medium is t1, a thickness of a transparent substrate of the second optical recording medium is t2, and a thickness of a transparent substrate of the third optical recording medium is t3. According to a sixteenth aspect of the present invention, the wavelength λ1 is 380 nm to 430 nm, the wavelength λ2 is 630 nm to 690 nm, and the wavelength λ3 is 760 nm to 810 nm in the above objective lens.

According to a seventeenth aspect of the present invention, there is provided an optical head which includes the objective lens according to the first aspect or the optical pickup system according to the tenth aspect. According to an eighteenth aspect of the present invention, there is provided an optical disc apparatus which includes the objective lens according to the first aspect or the optical pickup system according to the tenth aspect.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic view of an optical pickup system according to a first embodiment of the present invention;

FIGS. 2A and 2B are schematic views of an objective lens according to the first embodiment;

FIGS. 3A to 3C are lens data of an objective lens according to an example 1;

FIG. 4 is aspherical data of a lens surface on a light source side and a lens surface on an optical disc side of the objective lens according to the example 1;

FIGS. 5A to 5C are wavefront aberration charts of HD DVD, DVD and CD when using the objective lens according to the example 1;

FIG. 6 is a schematic view of an HD DVD, DVD optical pickup system which includes the objective lens according to the example 1;

FIG. 7 is a table showing the configuration of the HD DVD, DVD optical pickup system according to the example 1;

FIG. 8 is aspherical data of a divergence angle conversion lens according to the example 1;

FIGS. 9A and 9B are wavefront aberration charts of HD DVD and DVD in the optical pickup system according to the example 1;

FIGS. 10A, 10B and 10C are lens data of an objective lens according to an example 2;

FIG. 11 is aspherical data of a lens surface on a light source side and a lens surface on an optical disc side of the objective lens according to the example 2;

FIGS. 12A to 12C are wavefront aberration charts of HD DVD, DVD and CD when using the objective lens according to the example 2;

FIG. 13 is a table showing the configuration of the HD DVD, DVD optical pickup system according to the example 2;

FIG. 14 is aspherical data of a divergence angle conversion lens according to the example 2;

FIGS. 15A and 15B are wavefront aberration charts of HD DVD and DVD in the optical pickup system according to the example 2;

FIGS. 16A, 16B and 16C are lens data of an objective lens according to a comparative example;

FIG. 17 is aspherical data of a lens surface on a light source side and a lens surface on an optical disc side of the objective lens according to the comparative example;

FIG. 18 is a table showing the configuration of the HD DVD, DVD optical pickup system according to the comparative example; and

FIG. 19 is aspherical data of a divergence angle conversion lens according to the comparative example.

### DESCRIPTION OF THE PREFERRED EMBODIMENTS

An exemplary embodiment of the present invention is described hereinafter in detail with reference to the drawings. In the following embodiment, the present invention is applied to an objective lens and an optical pickup system. In the objective lens of this embodiment, when the imaging magnifications at first laser light having a first wavelength λ1, at second laser light having a second wavelength λ2 which is longer than λ1, and at third laser light having a third wavelength λ3 which is longer than λ2 are m1, m2 and m3, respectively, the relationships of m1>m2>0 and −0.060≦m3≦−0.020 are satisfied.

The laser light having the wavelength λ1 and λ2 are incident on an objective lens as convergent light, and the laser light having the wavelength λ3 is incident on an objective lens as divergent light. This allows the object distance at the wavelength λ3 to be long. The long object distance at the wavelength λ3 allows reduction of aberration due to oblique incidence which occurs during tracking servo control in a finite system or the like. Further, satisfying m1>m2 enables reduction of aberration on a recording surface of an optical recording medium with the laser light having the wavelength λ1 and the laser light having the wavelength λ2.

Thus, the objective lens of this embodiment reduces aberration by the control of imaging magnifications. Specifically, it reduces aberration due to oblique incidence during tracking servo control or the like by setting the imaging magnifications at the light of each wavelength to fall within the above range. Further, at least one lens surface of the objective lens is divided into a plurality of concentric sections with the optical axis, having a certain step at each boundary between the sections, thereby allowing the use of the same photodetector for both the light of the wavelength λ1 and the light of the wavelength λ2. In the following description, three kinds of optical discs, HD DVD, DVD and CD are taken as examples.

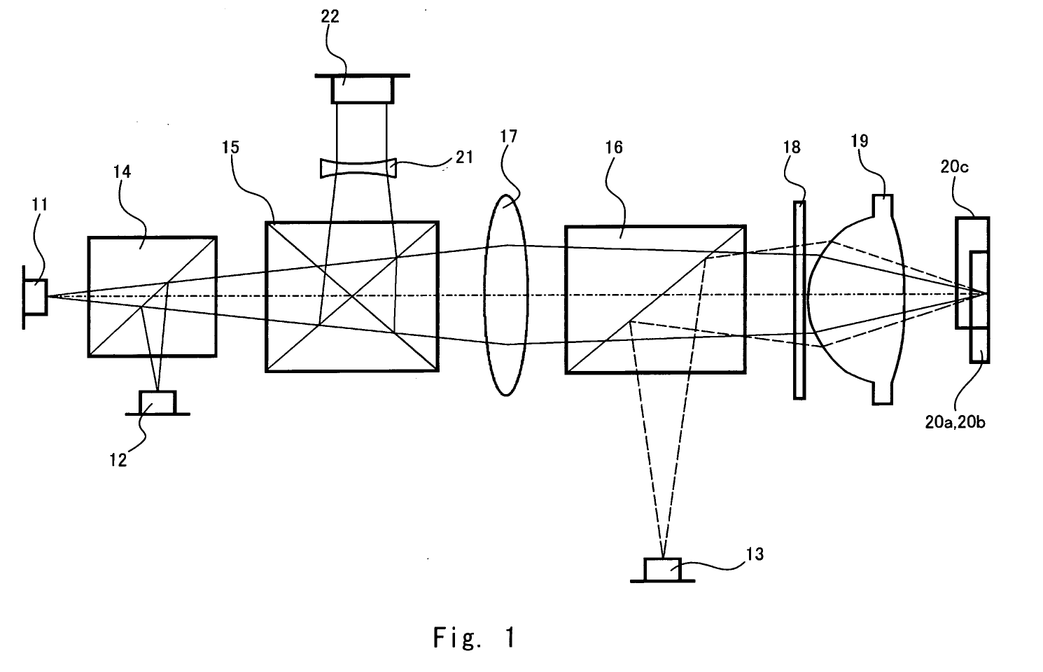

FIG. 1 is a schematic view showing the structure of an optical pickup system 1 according to this embodiment. The optical pickup system 1 of FIG. 1 includes an HD DVD light source 11, a DVD light source 12, a CD light source 13 including a first photodetector, a first beam splitter 14, a second beam splitter 15, a third beam splitter 16, a divergence angle conversion lens 17, a numerical aperture limiter 18, an objective lens 19, an HD DVD disc 20a, a DVD disc 20b, a CD disc 20c, a detection lens 21, and a second photodetector 22.

The HD DVD light source 11 emits light with the wavelength of 380 nm to 430 nm. The DVD light source 12 emits light with the wavelength of 630 nm to 690 nm. The CD light source 13 emits light with the wavelength of 760 nm to 810 nm. The present invention, however, is not limited to the use of those wavelengths. The CD light source 13 includes a first photodetector for detecting the light which is emitted from the CD light source 13 and reflected by the CD disc 20c.

The first beam splitter 14 is placed to guide the light from the HD DVD light source 11 and the light from the DVD light source 12 to a common optical path. Specifically, as shown in FIG. 1, the light from the HD DVD light source 11 passes through the first beam splitter 14 and the light from the DVD light source 12 is reflected by the first beam splitter 14, so that the both are guided to a common optical path.

The second beam splitter 15 transmits the light from the HD DVD light source 11 and the light from the DVD light source 12, and reflects the light from the HD DVD light source 11 which is reflected by the HD DVD disc 20a or the light from the DVD light source 12 which is reflected by the DVD disc 20b toward the detection lens 21. The light which is reflected by the second beam splitter 15 passes through the detection lens 21 and is then detected by the second photodetector 22.

The divergence angle conversion lens 17 converts the light from the HD DVD light source 11 and the light from the DVD light source 12, which have passed through the second beam splitter 15, into convergent light. The convergent light is the light whose width decreases as it propagates. The third beam splitter 16 reflects the light from the CD light source 13, so that it enters the objective lens 19. The light from the CD light source 13 is incident on the objective lens 19 as divergent light. The divergent light is the light whose width increases as it propagates. The third beam splitter 16 also reflects the light from the CD light source 13 which is reflected back by the CD disc 20c, so that it enters the first photodetector which is placed in the CD light source 13.

The numerical aperture limiter 18 limits the effective numerical aperture NA of the light which is incident on the objective lens 19. The numerical aperture limiter 18 controls the effective numerical aperture NA according to the wavelength of incident light. The effective numerical aperture NA is expressed as: effective diameter/(2*focal length). An example of the numerical aperture limiter 18 is a wavelength selective filter which adjusts a numerical aperture with the use of an optical filter film or a diffraction grating.

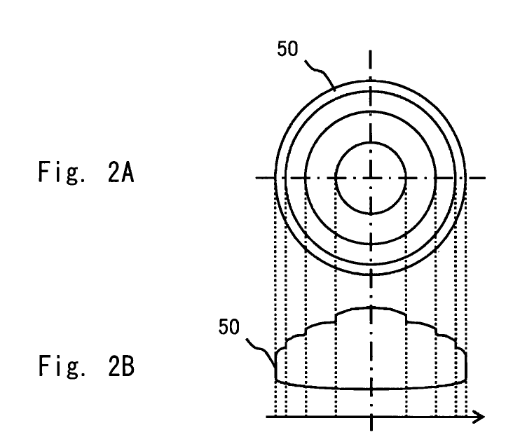

FIGS. 2A and 2B show schematic views of the objective lens 19 according to this embodiment. FIG. 2A is a front view of the objective lens 19, and FIG. 2B is a sectional view of the objective lens 19. At least one lens surface of the objective lens 19 is divided into a plurality of concentric sections with the optical axis. When the imaging magnification of light from the HD DVD light source 11 is m1, the imaging magnification of light from the DVD light source 12 is m2, and the imaging magnification of light from the CD light source 13 is m3, m1>m2×0 and −0.060≦m3≦−0.020 are satisfied.

A sign of the imaging magnification is positive in a convergent finite system, and it is negative in a divergent finite system. Thus, because m1 and m2 are positive values, the light from the HD DVD light source 11 and the light from the DVD light source 12 are incident on the objective lens 19 as convergent light, so that they are focused on the recording surface of the HD DVD disc 20a or the DVD disc 20b. On the other hand, because m3 is a negative value, the light from the CD light source 13 is incident on the objective lens 19 as divergent light, so that it is focused on the recording surface of the CD disc 20c.

Since the light from the HD DVD light source 11 and the light from the DVD light source 12 are incident on the objective lens 19 as convergent light, the object distance at the light from the CD light source 13 can be long. If the object distance at the light from the CD light source 13 increases, the light becomes closer to parallel light, which reduces the aberration due to oblique incidence by a tracking mechanism or the like. The reduction of aberration means to reduce the RWS wavefront aberration value to be within the Marechal criterion of 0.070 λrms, or preferably 0.040 λrms or lower.

The objective lens 19 of this embodiment reduces the aberration by the control of the imaging magnification at the light from the HD DVD light source 11 and the imaging magnification at the light from the DVD light source 12. Specifically, it reduces the aberration by setting the imaging magnifications to satisfy m1>m2. The reduction of aberration means to reduce the RWS wavefront aberration value to be within the Marechal criterion of 0.070 λrms, or preferably 0.040 λrms or lower.

Further, at least one lens surface of the objective lens 19 is divided into a plurality of concentric sections with the optical axis, and a certain step is formed at each boundary between the sections. With such a step, it is possible to use the same photodetector for detecting the light from the HD DVD light source 11 which is reflected by the HD DVD disc 20a and for detecting the light from the DVD light source 12 which is reflected by the DVD disc 20b.

It is preferred that each section has a different curvature radius and aspherical coefficient. This enables further reduction of aberration in the light from the HD DVD light source 11, the light from the DVD light source 12, and the light from the CD light source 13. Specific examples are described later.

It is also preferred that the objective lens of this embodiment is made of glass or plastic with an Abbe number vd of 50 or higher. If the Abbe number vd is smaller than 50, aberration due to a difference in wavelength increases upon the incidence of laser light with different wavelengths on the objective lens.

To reduce aberration, it is necessary to increase the number of concentric sections on the objective lens. This complicates the surface shape of the objective lens, thus complicating the manufacture of the objective lens. Further, the increase in the number of concentric sections on the objective lens causes an increase in light loss at each boundary between the sections, which leads to reduction in light use efficiency. According to this embodiment, it is possible to reduce the number of concentric sections on the objective lens 19 by setting the Abbe number vd to 50 or higher. It is also possible to form the objective lens 19 into a desired shape easily by using glass or plastic as its material.

The number of concentric sections on the objective lens 19 is preferably 2 to 10. By setting the number of sections into this range, it is possible to fabricate an objective lens with high light use efficiency. Further, when the thickness of the HD DVD disc 20a is t1, the thickness of the DVD disc 20b is t2 and the thickness of the CD disc 20c is t3, it is preferred to satisfy: t1=t2<t3.

In the optical pickup system using the objective lens of this embodiment, a distance from the HD DVD light source 11 to the objective lens 19 and a distance from the DVD light source 12 to the objective lens 19 are substantially equal. This easily allows the shared use of a photodetector for detecting the light from the HD DVD light source 11 which is reflected by the HD DVD disc 20a and a photodetector for detecting the light from the DVD light source 12 which is reflected by the DVD disc 20b. Therefore, the number of photodetectors can be two: a first detector as a photodetector for CD and a second detector 22 as a photodetector for HD DVD and DVD. This is advantageous in cost, easy alignment for photo-detection and so on.

The behavior of the laser light emitted from each light source is described hereinafter with reference to FIG. 1. The light from the HD DVD light source 11 passes through the first beam splitter 14 and enters the second beam splitter 15. The light from the DVD light source 12 is reflected by the first beam splitter 14 and enters the second beam splitter 15. The light from the HD DVD light source 11 and the light from the DVD light source 12 are guided to a common optical path.

Then, the light from the HD DVD light source 11 and the light from the DVD light source 12 pass through the second beam splitter 15 and enter the divergence angle conversion lens 17. The light from the HD DVD light source 11 and the light from the DVD light source 12 are converted into convergent light by the divergence angle conversion lens 17. The light then passes through the numerical aperture limiter 18 where its effective numerical aperture NA is limited and then enters the objective lens 19. The light incident on the objective lens 19 is converged by the objective lens 19 to be focused on the information recording surface of the HD DVD disc 20a or the DVD disc 20b, thus forming an optical spot.

The light which is reflected on the information recording surface of the HD DVD disc 20a or the DVD disc 20b again passes through the objective lens 19, the numerical aperture limiter 18, the third beam splitter 16 and the divergence angle conversion lens 17. After passing through the divergence angle conversion lens 17, the light is reflected by the second beam splitter 15 toward the detection lens 21. The light passes through the detection lens 21 and is then detected by the second photodetector 22 and photoelectrically converted, thus generating a focus servo signal, a tracking servo signal, a playback signal and so on.

On the other hand, the light from the CD light source 13 is reflected by the third beam splitter 16 and enters the numerical aperture limiter 18. The effective numerical aperture NA of the light from the CD light source 13 is controlled by the numerical aperture limiter 18. The light then enters the objective lens 19. This light is guided to a common optical path to the light from the HD DVD light source 11 and the light from the DVD light source 12. The light incident on the objective lens 19 is divergent light. The light incident on the objective lens 19 is converged by the objective lens 19 to be focused on the information recording surface of the CD disc 20c, thus forming an optical spot.

The light which is reflected on the information recording surface of the CD disc 20c again passes through the objective lens 19 and the numerical aperture limiter 18. After passing through the numerical aperture limiter 18, the light is reflected by the third beam splitter 16 toward the CD light source 13. The light is then detected by the first photodetector in the CD light source 13 and photoelectrically converted, thus generating a focus servo signal, a tracking servo signal, a playback signal and so on.

Specific examples of the objective lens and the optical pickup system according to the above-described embodiment of the present invention are described hereinafter.

### EXAMPLE 1

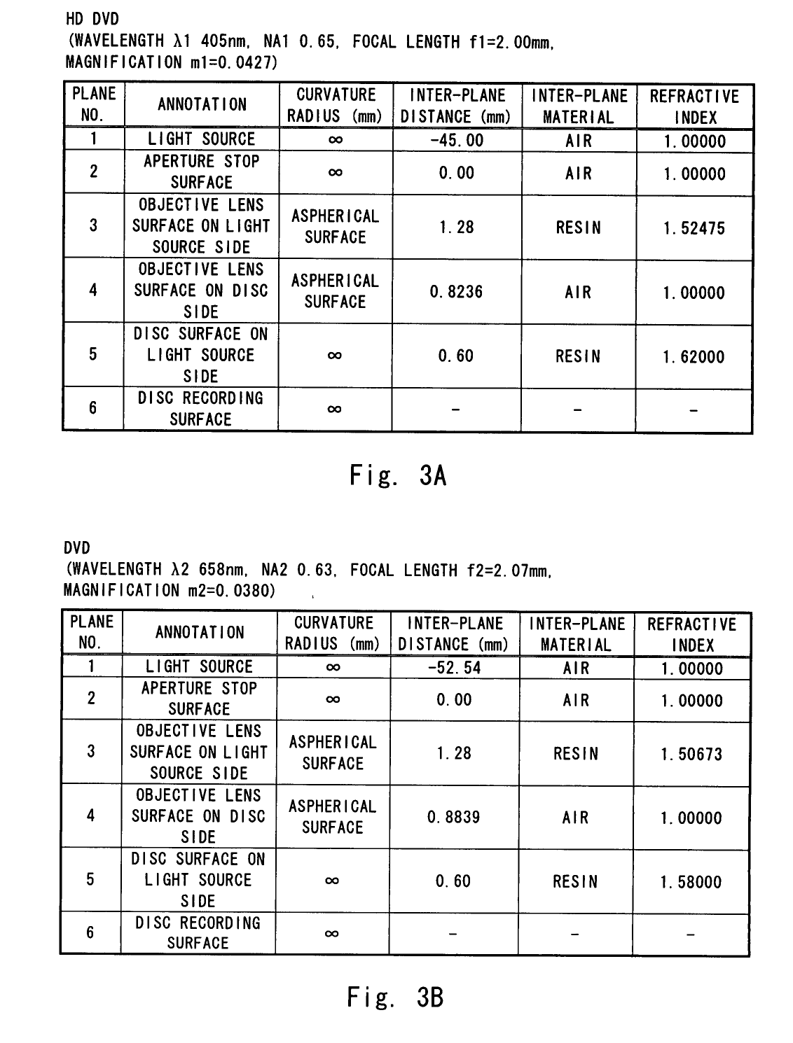

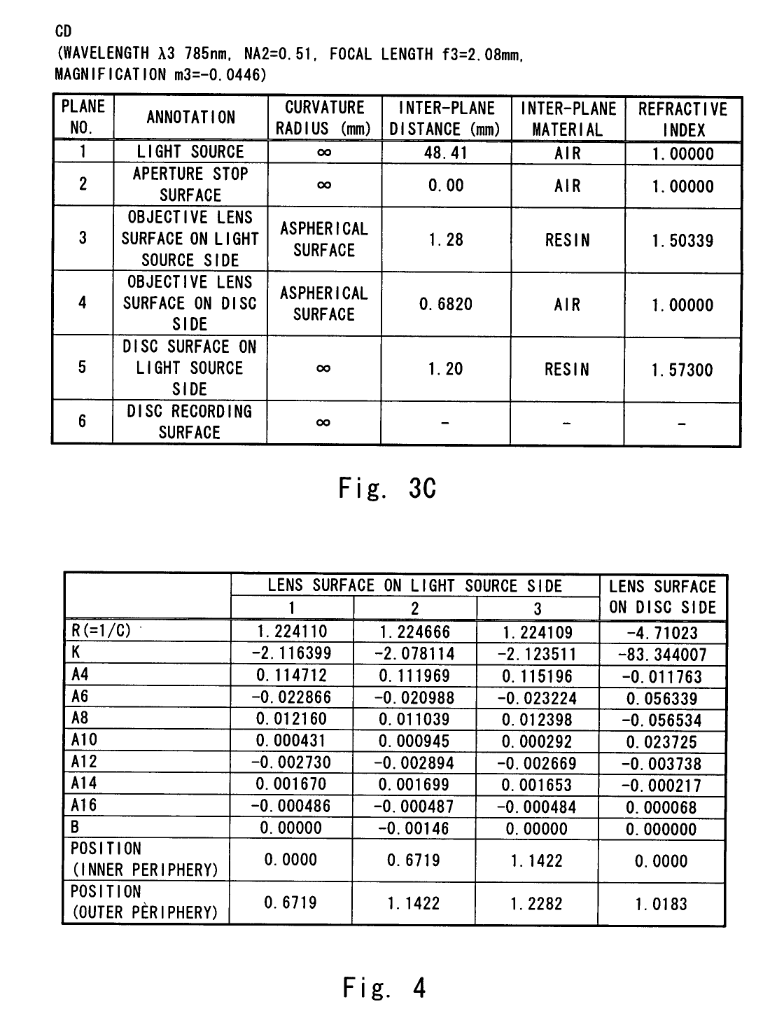

FIGS. 3A to 3C show lens data of the objective lens according to a first example. FIG. 3A shows the case of HD DVD. FIG. 3B shows the case of DVD. FIG. 3C shows the case of CD. In this example, the objective lens 19 is made of plastic with Abbe number vd=57. The aperture stop surface corresponds to the surface on which the numerical aperture limiter 18 is placed. The disc surface on the light source side corresponds to the surface of the optical disc 20, and the disc recording surface is the surface inside the optical disc 20 where information is recorded. In FIGS. 3A to 3C, a curvature radius, an inter-plane distance, an inter-plane material and a refractive index are shown for each surface.

The imaging magnifications m1, m2 and m3 in HD DVD, DVD and CD are m1=0.0427, m2=0.0380 and m3=−0.0446, respectively, thus satisfying the conditions for the objective lens in the above-described embodiment, which are: m1>m2×0 and −0.060≦m3≦−0.020. A sign of the magnification is positive when a distance from a light source to an aperture stop surface is negative, which is a so-called convergent finite system, and it is negative when a distance from a light source to an aperture stop surface is positive, which is a so-called divergent finite system.

The aspherical shape on the lens surface of the objective lens 19 which is designed on the basis of the lens data shown in FIGS. 3A to 3B is expressed as follows:

$$\text{Expression 1:}$$

$${Z}_{j} = \frac{{Ch}^{2}}{1 + \sqrt{1 - ( K + 1 ) {C}^{2} \cdot {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} + B$$

In Expression 1, a distance (sag) from a tangent plane in an optical axis on an aspherical surface at a coordinate point on the aspherical surface with a height h from the optical axis is Zj(h), a curvature (1/curvature radius) in the optical axis on the aspherical surface is C, a conic coefficient is K, the fourth to sixteenth aspherical coefficients are A4, A6, A8, A10, A12, A14 and A16, respectively. B indicates a sag amount in an optical axis.

FIG. 4 shows the coefficient table that indicates the aspherical shape of the lens surface on the side of the light sources 11 to 13 and the lens surface on the side of the optical disc 20 in the objective lens 19 of this example with the above expression. The lens surface of the objective lens 19 on the side of the light sources 11 to 13 is divided into three sections. The three sections are ring zone-shaped, and the position of the ring zone in each section is also described. A curvature radius R (1/C) and an aspherical coefficient are different from section to section, and they are set so as to reduce the wavefront aberration for both HD DVD and DVD. It is thereby possible to minimize the deterioration of light use efficiency at each boundary between the sections.

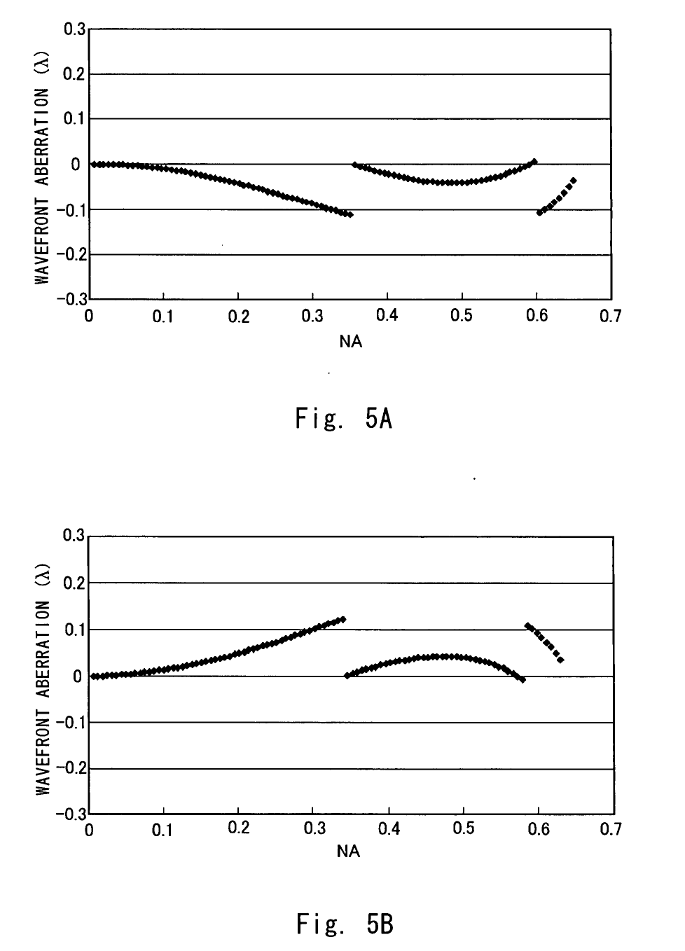

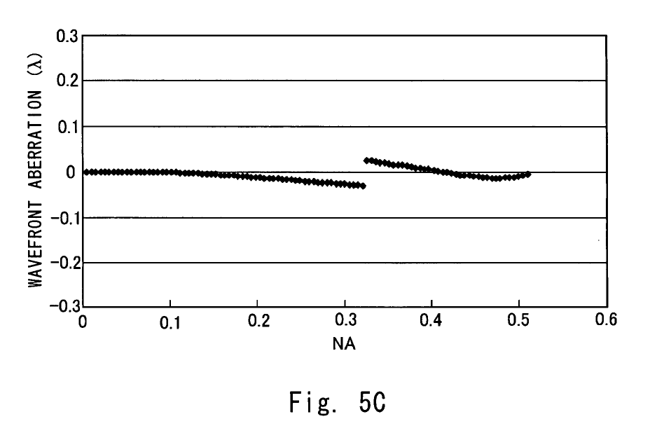

FIGS. 5A to 5C show the wavefront aberration charts of HD DVD, DVD and CD with the use of the objective lens according to this example. FIG. 5A is a calculation result of the wavefront aberration distribution in HD DVD. FIG. 5B is a calculation result of the wavefront aberration distribution in DVD. FIG. 5C is a calculation result of the wavefront aberration distribution in CD. In the graphs of FIGS. 5A to 5C, the horizontal axis indicates the effective numerical aperture NA, and the vertical axis indicates the wavefront aberration. As shown in FIGS. 5A to 5C, the RMS wavefront aberration value in HD DVD is 0.0304 λrms, the RMS wavefront aberration value in DVD is 0.0320 λrms, and the RMS wavefront aberration value in CD is 0.0135 λrms. Thus, all the values are below the Marechal criterion of 0.070 λrms and further a preferable value of 0.040 λrms. Accordingly, the wavefront aberration is reduced sufficiently in each case.

The RMS wavefront aberration value with the objective lens shift of 0.3 mm during tracking is 0.0312 (0.0017) λrms in HD DVD, 0.0348 (0.0130) λrms in DVD, and 0.0451 (0.0441) λrms in CD (the values in parentheses indicates COMA3). Thus, all the values are below the Marechal criterion of 0.070 λrms.

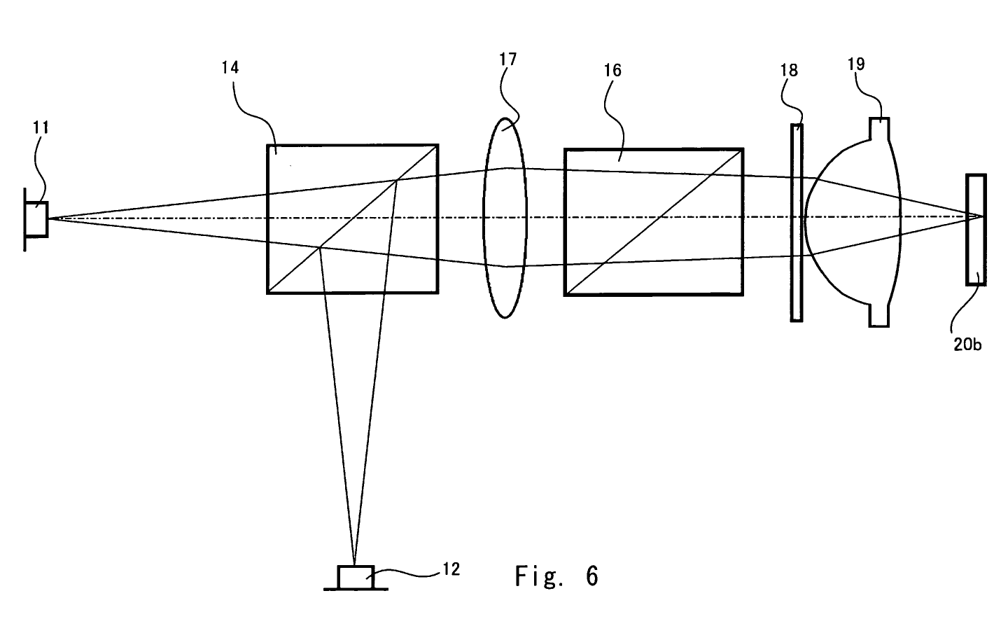

In the objective lens of this example, the wavefront aberration chart when a photodetector in an optical pickup system is shared for the detection of the light from the HD DVD light source 11 and the light from the DVD light source 12 is calculated by focusing attention on those light. In order to use the same photodetector for HD DVD and DVD, a distance from each light source to a divergence angle conversion lens surface is set to be the same. In this example, the HD DVD light source 11 and the DVD light source 12 are separately placed. With the use of a dual wavelength laser unit in which both the HD DVD light source 11 and the DVD light source 12 are prepared in a common package, the distance from each light source to a divergence angle conversion lens surface can also be the same. FIG. 6 is a schematic view of an HD DVD, DVD optical pickup system which includes the objective lens of this example. The optical system includes the HD DVD light source 11, the DVD light source 12, the first beam splitter 14, the divergence angle conversion lens 17, the numerical aperture limiter 18, the objective lens 19, the HD DVD disc 20a, and the DVD disc 20b.

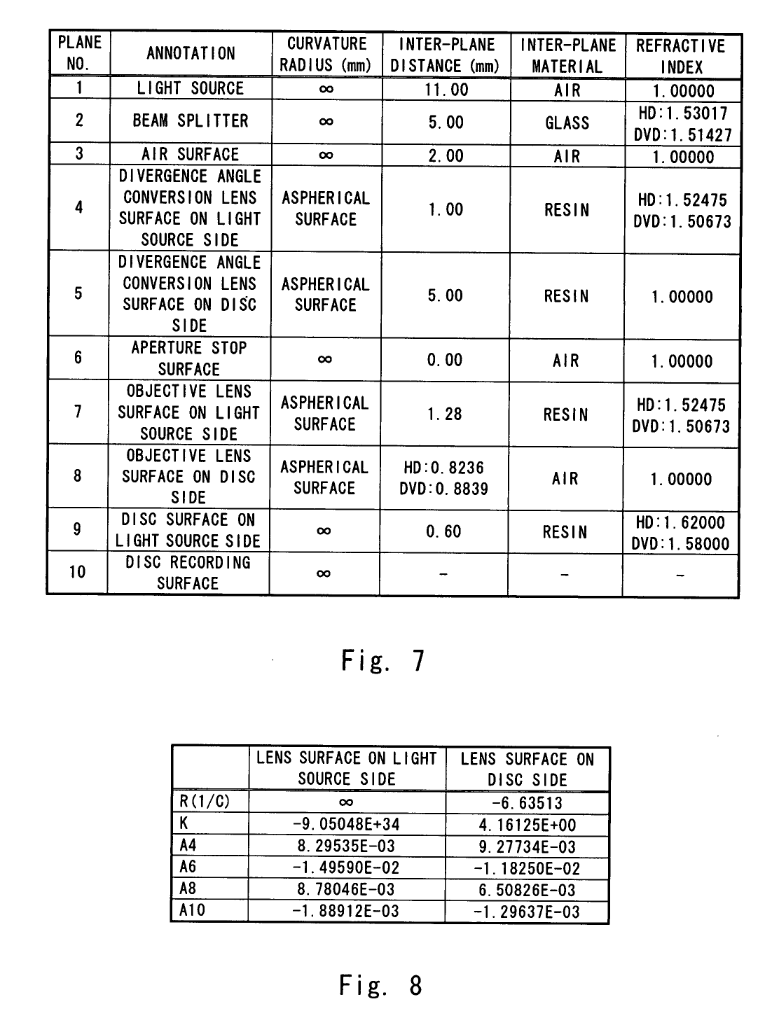

FIG. 7 is a table showing the configuration in the HD DVD, DVD optical pickup system. FIG. 8 shows aspherical data in the divergence angle conversion lens 17. In FIG. 7, a curvature radius on each plane, an inter-plane distance, an inter-plane material, and a refractive index of the material are shown for each surface. FIG. 8 shows the aspherical coefficient, the conic coefficient K and the curvature radius K in the above Expression 1 on the surfaces of the divergence angle conversion lens 17 on the side of the light sources 11 and 12 and on the side of the optical discs 20a and 20b.

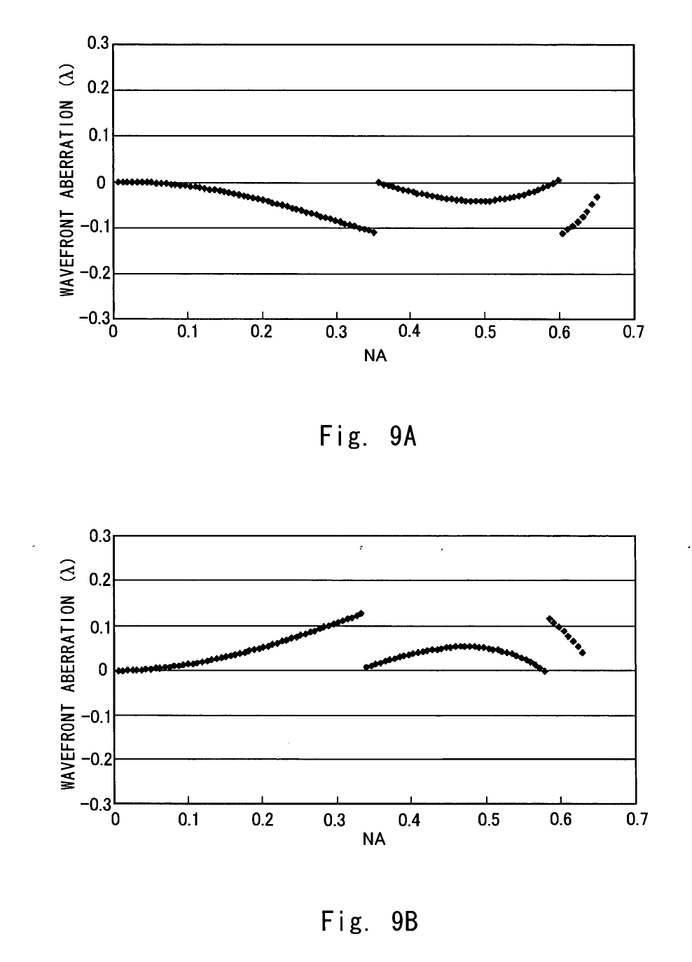

As shown in FIG. 8, a distance from each light source to the divergence angle conversion lens surface is the same for HD DVD and DVD. This enables the shared use of a detector for both HD DVD and DVD. FIGS. 9A and 9B show the wavefront aberration charts for HD DVD and DVD in the optical pickup system. FIG. 9A is a calculation result of the wavefront aberration distribution in HD DVD. FIG. 9B is a calculation result of the wavefront aberration distribution in DVD. The RMS wavefront aberration value in HD DVD is 0.0305 λrms, and the RMS wavefront aberration value in DVD is 0.0316 λrm. These RMS wavefront aberration values are below the Marechal criterion of 0.070 λrms and further a preferable value of 0.040 λrms. Accordingly, the wavefront aberration is reduced sufficiently in each case.

### EXAMPLE 2

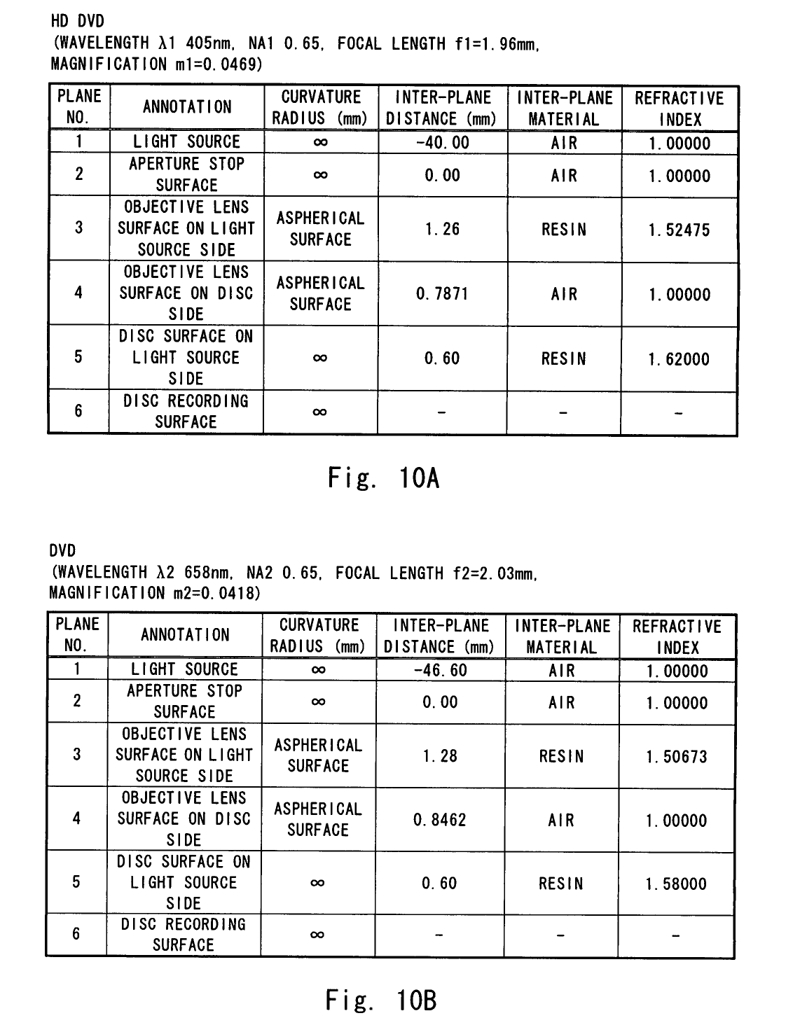

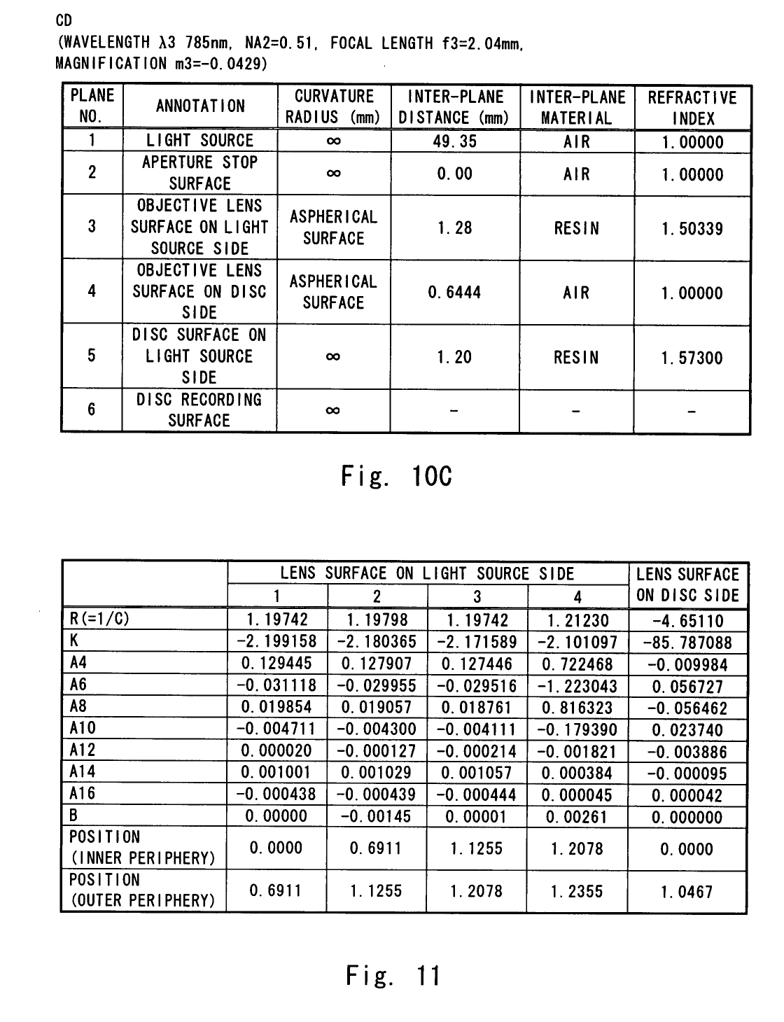

FIGS. 10A to 10C show lens data of the objective lens according to an example 2. FIG. 10A shows the case of HD DVD. FIG. 10B shows the case of DVD. FIG. 10C shows the case of CD. In this example, the objective lens 19 is made of plastic with Abbe number vd=57. The aperture stop surface corresponds to the surface on which the numerical aperture limiter 18 is placed. The disc surface on the light source side corresponds to the surface of the optical disc 20, and the disc recording surface is the surface inside the optical disc 20 where information is recorded. In FIGS. 10A to 10C, a curvature radius of each surface, an inter-plane distance, an inter-plane material and a refractive index are shown for each surface.

In the objective lens of this example, NAs of HD DVD and DVD are both 0.65, and a section for reducing the aberration for DVD only is placed outside of the effective region for HD DVD. Accordingly, the objective lens of this example is divided into four ring zones, in which the three inner ring zones serve as the effective region for light from the HD DVD light source, and the outermost ring zone serves as a dedicated region for light from the DVD light source.

The imaging magnifications m1, m2 and m3 in HD DVD, DVD and CD are m1=+0.0469, m2=+0.0418 and m3=−0.0429, respectively, thus satisfying the conditions for the objective lens in the above-described embodiment, which are: m1>m2×0 and −0.060≦m3≦−0.020.

FIG. 11 shows the coefficient table that indicates the aspherical shape of the lens surface on the side of the light sources 11 to 13 and the lens surface on the side of the optical disc 20 in the objective lens 19 of this example with the above expression. The lens surface of the objective lens 19 on the side of the light sources 11 to 13 is divided into four sections. The four sections are ring zone-shaped, and the position of the ring zone in each section is also described. A curvature radius R (1/C) and an aspherical coefficient are different from section to section, and they are set so as to reduce the wavefront aberration for both HD DVD and DVD. Further, in this example, the first to third sections are designed to reduce the wavefront aberration for both HD DVD and DVD, and the fourth section is designed to reduce the wavefront aberration for DVD only as described above. The number of sections in the objective lens of the example 2 is four, thus minimizing the deterioration of light use efficiency at each boundary between the sections.

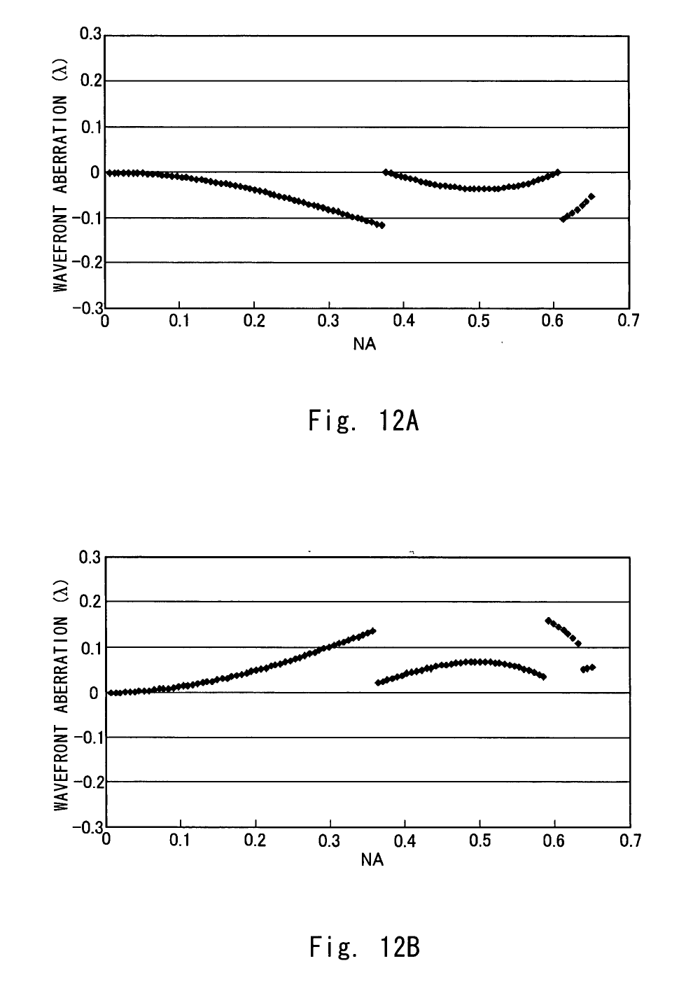

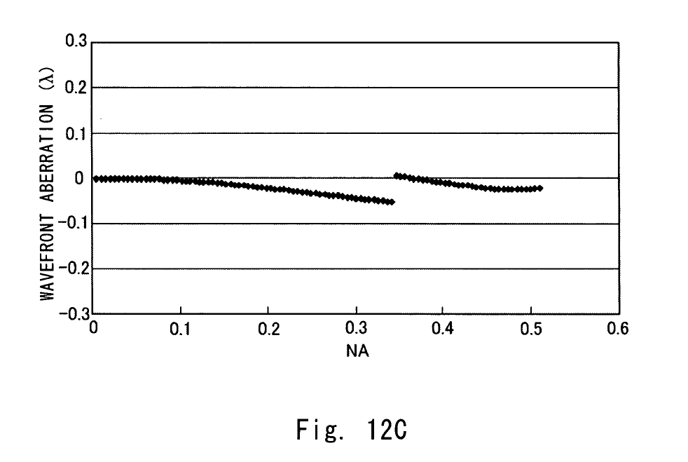

FIGS. 12A to 12C show the wavefront aberration charts of HD DVD, DVD and CD with the use of the objective lens according to this example. FIG. 12A is a calculation result of the wavefront aberration distribution in HD DVD. FIG. 12B is a calculation result of the wavefront aberration distribution in DVD. FIG. 12C is a calculation result of the wavefront aberration distribution in CD. In the graphs of FIGS. 12A to 12C, the horizontal axis indicates the effective numerical aperture NA, and the vertical axis indicates the wavefront aberration. As shown in FIGS. 12A to 12C, the RMS wavefront aberration value in HD DVD is 0.0324 λrms, the RMS wavefront aberration value in DVD is 0.0276 λrms, and the RMS wavefront aberration value in CD is 0.0145 λrms. Thus, all the values are below the Marechal criterion of 0.070 λrms and further a preferable value of 0.040 λrms. Accordingly, the wavefront aberration is reduced sufficiently in each case.

The RMS wavefront aberration value with the objective lens shift of 0.3 mm during tracking is 0.0331 (0.0008) λrms in HD DVD, 0.0382 (0.0169) λrms in DVD, and 0.0416 (0.0385) λrms in CD (the values in parentheses indicates COMA3). Thus, all the values are below the Marechal criterion of 0.070 λrms.

In the objective lens of this example, the wavefront aberration chart when a photodetector in an optical pickup system is shared for the detection of the light from the HD DVD light source 11 and the light from the DVD light source 12 is calculated by focusing attention on those light. In order to use the same photodetector for HD DVD and DVD, a distance from each light source to a divergence angle conversion lens surface is set to be the same. A schematic view of the optical pickup system in this example is the same as in the example 1, which is shown in FIG. 6.

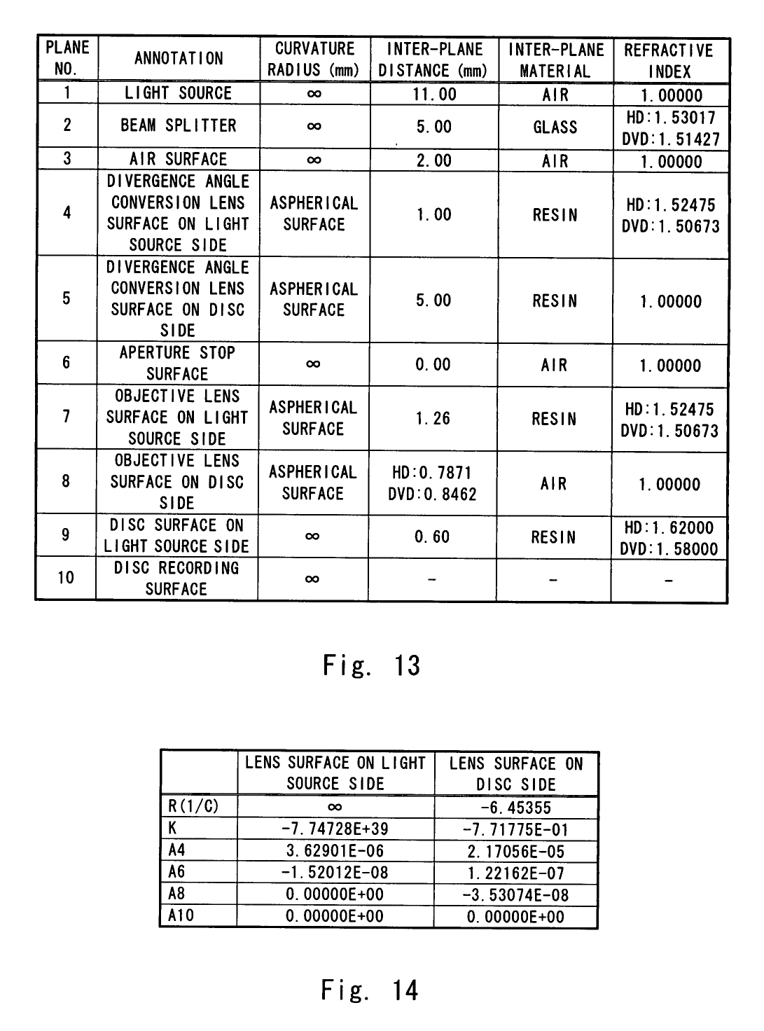

FIG. 13 is a table showing the configuration in the HD DVD, DVD optical pickup system. FIG. 14 shows aspherical data in the divergence angle conversion lens 17. In FIG. 13, a curvature radius on each plane, an inter-plane distance, an inter-plane material, and a refractive index of the material are shown for each surface. FIG. 14 shows the aspherical coefficient, the conic coefficient K and the curvature radius R in the above Expression 1 on the surfaces of the divergence angle conversion lens 17 on the side of the light sources 11 and 12 and on the side of the optical discs 20a and 20b.

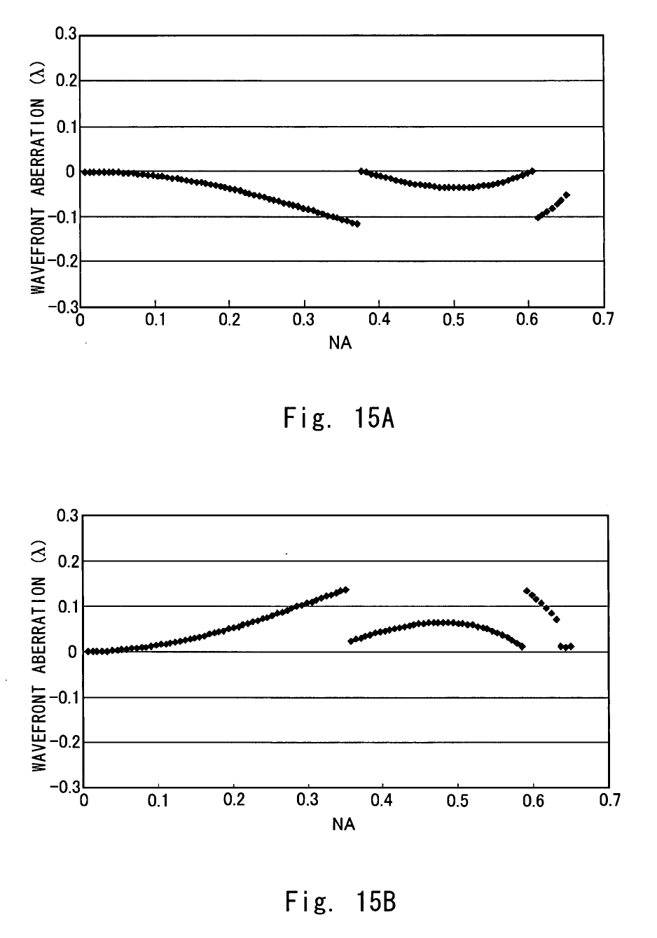

As shown in FIG. 13, a distance from each light source to the divergence angle conversion lens surface is the same for HD DVD and DVD. This enables the shared use of a detector for both HD DVD and DVD. FIGS. 15A and 15B show the wavefront aberration charts for HD DVD and DVD in the optical pickup system. FIG. 15A is a calculation result of the wavefront aberration distribution in HD DVD. FIG. 15B is a calculation result of the wavefront aberration distribution in DVD. The RMS wavefront aberration value in HD DVD is 0.0324 λrms, and the RMS wavefront aberration value in DVD is 0.0346 μrm. These RMS wavefront aberration values are below the Marechal criterion of 0.070 λrms and further a preferable value of 0.040 λrms. Accordingly, the wavefront aberration is reduced sufficiently in each case.

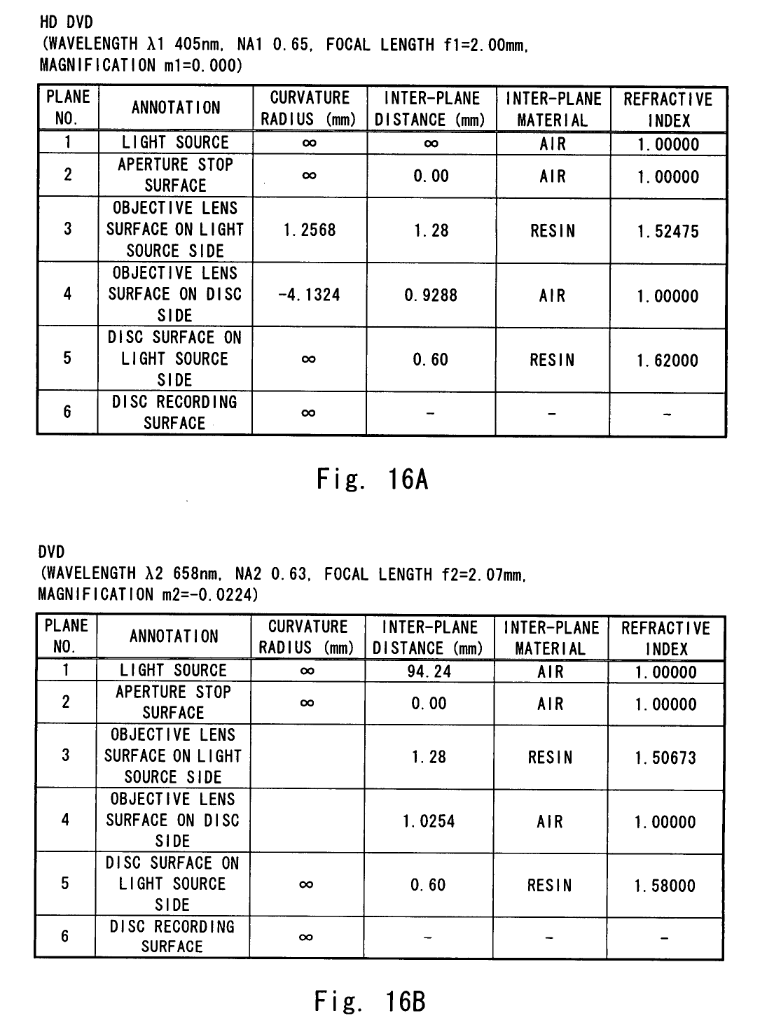

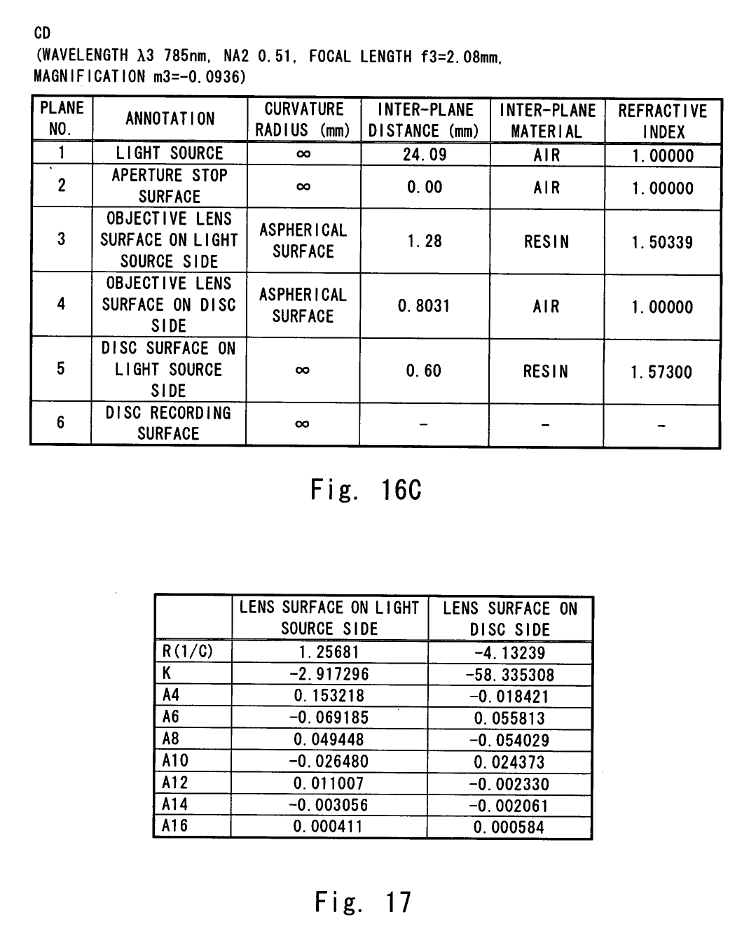

A comparative example with the use of an objective lens according to a related art is described hereinbelow. FIGS. 16A to 16C show lens data of the objective lens according to the comparative example. FIG. 16A shows the case of HD DVD. FIG. 16B shows the case of DVD. FIG. 16C shows the case of CD. FIG. 17 shows aspherical data of an objective lens according to the comparative example.

The objective lens of the comparative example has a single aspherical surface on both of the lens surface on the light source side and the lens surface on the disc side, and the magnifications are set to minimize the wavefront aberration for each of HD DVD, DVD and CD. The magnifications m1, m2 and m3 in HD DVD, DVD and CD are m1=0.000, m2=−0.0224 and m3=−0.0936, respectively, which fails to satisfy the conditions for the objective lens in the above-described embodiment, which are: m1>m2×0 and −0.060≦m3≦−0.020.

The RMS wavefront aberration value in HD DVD is 0.0008 λrms, the RMS wavefront aberration value in DVD is 0.0042 λrms, and the RMS wavefront aberration value in CD is 0.0016 λrms. All the values are below the Marechal criterion of 0.070 λrms.

However, the wavefront aberration value with the objective lens shift of 0.3 mm during tracking is 0.0898 λrms in CD, which exceeds the Marechal criterion of 0.070 λrms. Thus, the aberration by the lens becomes excessively large if the objective lens is shifted upon tracking.

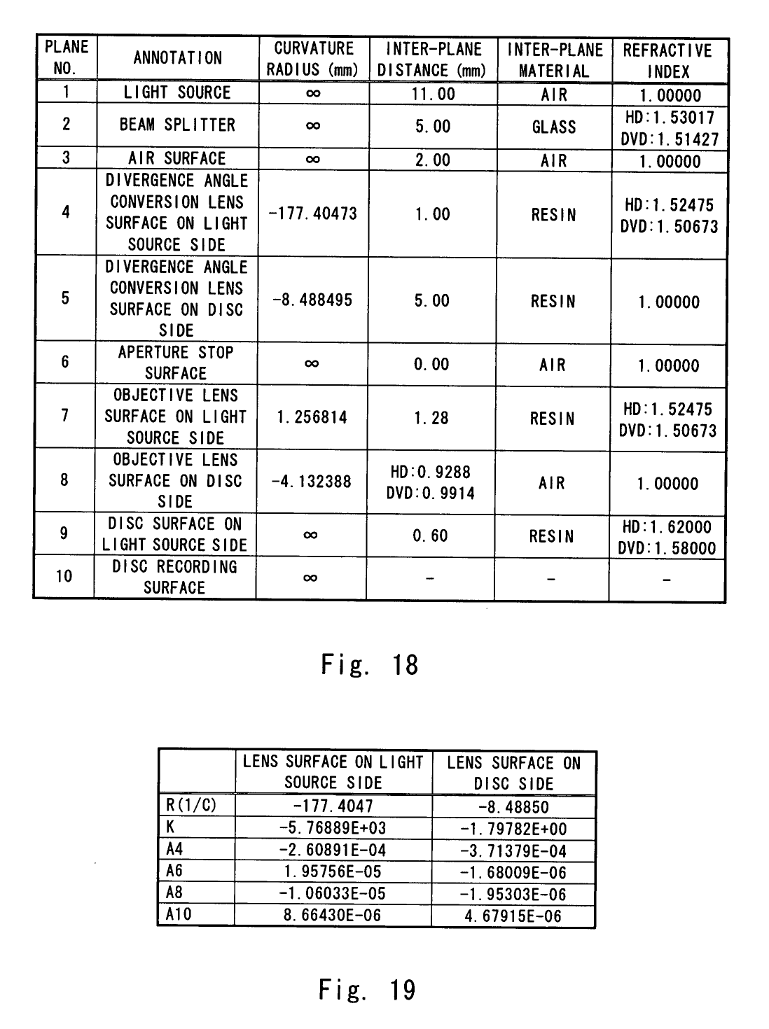

FIG. 18 is a table showing the configuration in the HD DVD, DVD optical pickup system which includes the objective lens of this comparative example. FIG. 19 shows aspherical data in the divergence angle conversion lens. As shown in FIG. 19, a distance from a light source to a collimator lens surface is the same for HD DVD and DVD. This enables the shared use of a detector for both HD DVD and DVD. However, the RMS wavefront aberration value in this pickup optical system is 0.0009 λrms in HD DVD and 0.1185 λrms in DVD. The value for DVD exceeds the Marechal criterion of 0.070 λrms.

As described in the foregoing, the degradation of wavefront aberration during tracking can be suppressed by dividing at least one lens surface of the objective lens into a plurality of concentric sections with the optical axis and satisfying m1>m2×0 and −0.060≦m3≦−0.020 where the imaging magnifications for HD DVD, DVD and CD in the objective lens are m1, m2 and m3, respectively. By setting the magnifications into the above range, it is possible to provide an objective lens which assures the high light use efficiency and the suppressed wavefront aberration for a plurality of kinds of optical recording media.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. An optical pickup system comprising:
a first light source emitting first light having a wavelength λ1;
a second light source emitting second light having a wavelength λ2 longer than the wavelength λ1;
a third light source emitting third light having a wavelength λ3 longer than the wavelength λ2; and
an objective lens focusing the first light on an information recording surface of a first optical recording medium, focusing the second light on an information recording surface of a second optical recording medium, and focusing the third light on an information recording surface of a third optical recording medium, wherein
at least one lens surface of the objective lens is divided into a plurality of concentric sections with an optical axis, having a step at each boundary between the sections, each of the sections has a different aspherical shape and
m1>m2×0 and −0.060≦m3<−0.020 are satisfied where an imaging magnification at the first light is m1, an imaging magnification at the second light is m2, and an imaging magnification at the third light is m3 in the objective lens.

2. The optical pickup system according to claim 1, wherein the step and the aspherical shape on at least one lens surface of the objective lens are designed to reduce the spherical aberration for both a first optical recording medium an a second recording medium.

3. The optical pickup system according to claim 2, further comprising a divergence angle conversion lens converting the first light and the second light into convergent light, wherein a distance from the first light source to the divergence angle conversion lens and a distance from the second light source to a divergence angle conversion lens are substantially equal.

4. The optical pickup system according to claim 3, wherein the first light source and the second light source are prepared in common package.

5. The optical pickup system according to claim 1, wherein the objective lens is made of a material with an Abbe number vd of 50 or higher.

6. The optical pickup system according to claim 5, wherein the material of the objective lens is plastic.

7. The optical pickup system according to claim 1, wherein the number of the sections is 2 to 10.

8. The optical pickup system according to claim 1, wherein t1=t2<t3 is satisfied where a thickness of a transparent substrate of the first optical recording medium is t1, a thickness of a transparent substrate of the second optical recording medium is t2, and a thickness of a transparent substrate of the third optical recording medium is t3.

9. The optical pickup system according to claim 1, wherein the wavelength λ1 is 380 nm to 430 nm, the wavelength λ2 is 630 nm to 690 nm, and the wavelength λ3 is 760 nm to 810 nm.

10. An objective lens for an optical pickup system focusing a light emitted from a first light source having a wavelength λ1 on an information recording surface of a first optical recording medium, focusing a light emitted from a second light source having a wavelength λ2 longer than the wavelength λ1 on an information recording surface of a second optical recording medium, and focusing a light emitted from a third light source having a wavelength λ3 longer than the wavelength λ2 on an information recording surface of a third optical recording medium, recording and/or playback information, and wherein
at least one lens surface of the objective lens is divided into a plurality of concentric sections through a certain step with an optical axis, having a step at each boundary between the sections, each of the sections has a different aspherical shape, and
m1>m2×0 and −0.060≦m3≦−0.020 are satisfied where an imaging magnification at the light having the wavelength λ1 is m1, an imaging magnification at the light having the wavelength λ2 is m2, and an imaging magnification at the light having the wavelength λ3 is m3 in the objective lens.

11. The objective lens according to claim 10, wherein the step and the aspherical shape on at least one lens surface of the objective lens are designed to reduce the spherical aberration for both a first optical recording medium an a second recording medium.

12. The objective lens according to claim 10, wherein the objective lens is made of a material with an Abbe number vd of 50 or higher.

13. The objective lens according to claim 12, wherein the material of the objective lens is plastic.

14. The objective lens according to claim 10, wherein the number of the sections is 2 to 10.

15. The objective lens according to claim 10, wherein t1=t2<t3 is satisfied where a thickness of a transparent substrate of the first optical recording medium is t1, a thickness of a transparent substrate of the second optical recording medium is t2, and a thickness of a transparent substrate of the third optical recording medium is t3.

16. The objective lens according to claim 1; wherein the wavelength λ1 is 380 nm to 430 nm, the wavelength λ2 is 630 nm to 690 nm, and the wavelength λ3 is 760 nm to 810 nm.

17. An optical head comprising the objective lens according to claim 1.

18. An optical disc apparatus comprising the objective lens according to claim 1.

19. An optical head comprising the optical pickup system according to claim 10.

20. An optical disc apparatus comprising the optical pickup system according to claim 10.
